(19) United States
(12) Patent Application Publication
(10) Pub. No.: US 2011/0227688 A1
(43) Pub. Date: Sep. 22, 2011

(54) PLANAR TRANSFORMER

(75) Inventors: Geun Young PARK, Suwon (KR); Sung Ho KIM, Hwaseong (KR); Sang Joon SEO, Suwon (KR); Kwang Seung CHO, Suwon (KR); Heung Gyoon CHOI, Suwon (KR)

(73) Assignee: SAMSUNG ELECTRO-MECHANICS CO., LTD., Suwon (KR)

(21) Appl. No.: 13/028,722

(22) Filed: Feb. 16, 2011

(30) Foreign Application Priority Data
Mar. 22, 2010 (KR) 10-2010-0025228

(51) Int. Cl. H01F 27/28

(52) U.S. Cl. 336/200

(57) ABSTRACT

There is provided a planar transformer having improved performance through a reduction in heat generation by removing part of a conductor from a substrate. The planar transformer includes a core part having a pair of cores being electromagnetically coupled to each other; a substrate part having at least one substrate disposed between the pair of cores; a pattern part formed on the at least one substrate and including a conductor having an adjustable width; and an opening part including a non-conductor allowing for variations in the width of the conductor of the pattern part.

### CROSS-REFERENCE TO RELATED APPLICATIONS

This application claims the priority of Korean Patent Application No. 10-2010-0025228 filed on Mar. 22, 2010, in the Korean Intellectual Property Office, the disclosure of which is incorporated herein by reference.

### BACKGROUND OF THE INVENTION

1. Field of the Invention

The present invention relates to a planar transformer, and more particularly, to a planar transformer having improved performance through a reduction in heat generation by removing parts of a conductor from a substrate.

2. Description of the Related Art

In recent years, various electronic devices have been encompassed by the trend for slimness. In line with the trend, a power supply device is also required to be slim.

Basically, a power supply device may achieve slimness by causing a power stage to be driven at high frequencies; however, its slimness is often limited due to a magnetic device and a capacitor.

In this regard, a capacitor being low in height or small in diameter, suitable for a slim power supply device, is being developed so as to meet the requirement of slimness.

Also, in the case of a transformer, which is a representative magnetic device, slimness may generally be achieved by stacking a multi-layer substrate having a circuit printed thereon and realizing magnetic device windings.

A planar transformer may form a current flow path by using a pattern formed on each substrate, the pattern being substituted for a coil of a general transformer.

However, when current flows through the pattern, heat is generated. The heat generated from such a pattern formed on each of a plurality of stacked substrates is beyond an optimum level required by a user.

### SUMMARY OF THE INVENTION

An aspect of the present invention provides a planar transformer having improved performance through a reduction in heat generation by removing parts of a conductor from a substrate.

According to an aspect of the present invention, there is provided a planar transformer including: a core part having a pair of cores being electromagnetically coupled to each other; a substrate part having at least one substrate disposed between the pair of cores; a pattern part formed on the at least one substrate and including a conductor having an adjustable width; and an opening part including a non-conductor allowing for variations in the width of the conductor of the pattern part.

The at least one substrate of the substrate part may have a through hole coupled to the core part.

The pattern part may be formed circumferentially around the through hole of the at least one substrate.

The pattern part may be formed in a spiral shape circumferentially around the through hole of the at least one substrate.

The substrate part may include a first substrate and a second substrate being stacked. The pattern part may include a primary conductor formed on the first substrate and a secondary conductor formed on the second substrate. The primary and secondary conductors may have a preset winding ratio therebetween.

The opening part may include a first opening disposed on a portion of the pattern part overlapped by the core part.

The opening part may include a second opening disposed on a portion of the pattern part that is not overlapped by the core part (such that the portion of the pattern part is exposed).

The first and second openings may be connected to each other.

The opening part may be formed within the conductor of the pattern part.

The substrate part may further include at least one ground substrate. The ground substrate may have a ground pattern formed on a surface thereof, the ground pattern being formed of a conductor. The ground pattern may be electrically connected to a ground of the pattern part formed on the at least one substrate.

According to another aspect of the present invention, there is provided a planar transformer including: a core part having a pair of cores being electromagnetically coupled to each other; a substrate part having at least one substrate disposed between the pair of cores; a pattern part formed on the at least one substrate and including a conductor; and an opening part formed by removing part of the conductor of the pattern part.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other aspects, features and other advantages of the present invention will be more clearly understood from the following detailed description taken in conjunction with the accompanying drawings, in which:

FIG. 1 is a schematic exploded view illustrating the configuration of a planar transformer according to an exemplary embodiment of the present invention;

FIG. 2 is a view illustrating the configuration of a pattern part and an opening part according to an exemplary embodiment of the present invention;

FIG. 3 is a view illustrating the configuration of a pattern part and an opening part according to another exemplary embodiment of the present invention;

FIG. 4 is an image showing heat generated from a circuit board on which a planar transformer according to an exemplary embodiment of the present invention is mounted and from a circuit board on which a planar transformer according to the related art is mounted; and

FIG. 5 is a schematic exploded view illustrating the configuration of a planar transformer according to another exemplary embodiment of the present invention.

### DETAILED DESCRIPTION OF THE PREFERRED EMBODIMENT

Exemplary embodiments of the present invention will now be described in detail with reference to the accompanying drawings.

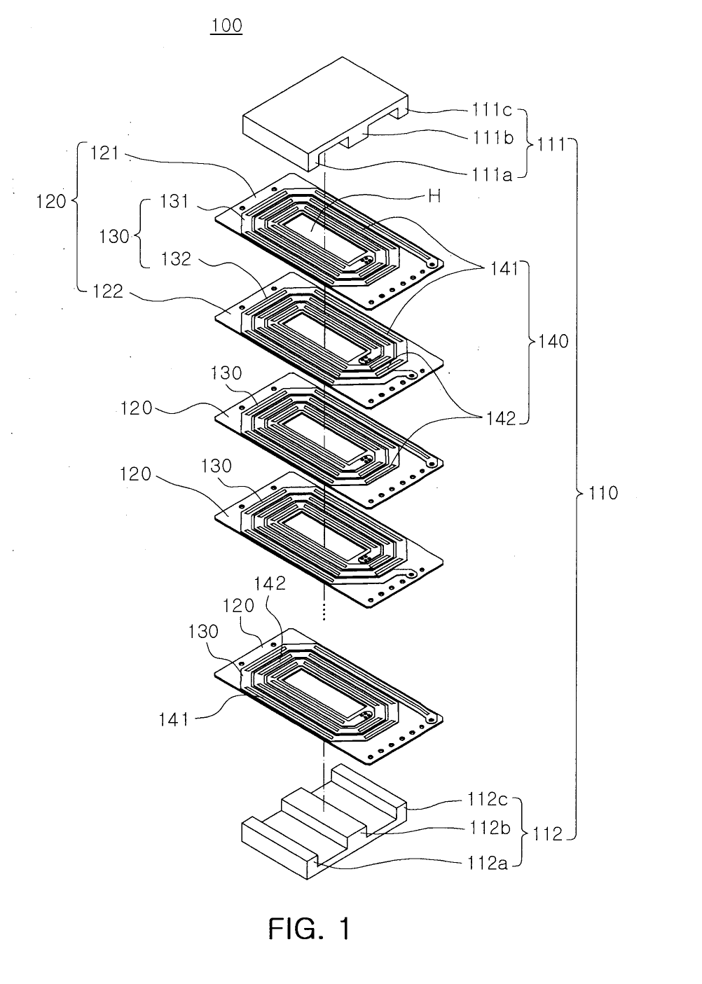

FIG. 1 is a schematic exploded view illustrating the configuration of a planar transformer according to an exemplary embodiment of the present invention.

With reference to FIG. 1, a planar transformer 100 according to an exemplary embodiment of the invention may include a core part 110, a substrate part 120, a pattern part 130, and an opening part 140.

The core part 110 may include a pair of cores 111 and 112 being electromagnetically coupled to each other.

The pair of cores 111 and 112 each may include legs for the electromagnetic coupling.

The pair of cores 111 and 112 may be an EE core as shown in FIG. 1, but it may also be another core, such as an EI core, a UU core, and a UI core.

The pair of cores 111 and 112 may be electromagnetically coupled to, each other by coupling first to third legs 111a, 111b, and 111c of the core 111 to first to third legs 112a, 112b, and 112c of the core 112.

The substrate part 120 may be provided between the pair of cores 111 and 112.

The substrate part 120 may include at least one substrate, and may further include a plurality of substrates.

As shown in FIG. 1, the substrate part 120 may include a plurality of substrates to be stacked upon one another. A through hole H may be formed in each of the plurality of substrates such that the legs of the pair of cores 111 and 112 may be inserted into the plurality of substrates.

The plurality of substrates may be a printed circuit board (PCB) on which a circuit can be printed.

The pattern part 130 may be formed on each of the plurality of substrates.

The pattern part 130 may be formed of a conductor through which current can flow. The conductor may have an adjustable width.

The pattern part 130 may serve as primary and secondary coils of a general transformer having a winding ratio therebetween.

For example, in the case that the substrate part 120 includes a first substrate 121 and a second substrate 122, a primary conductor 131 of the pattern part 130 is formed on the first substrate 121 and a secondary conductor 132 of the pattern part 130 is formed on the second substrate 122. Here, the primary and secondary conductors 131 and 132 may have a preset winding ratio therebetween.

The primary and secondary conductors 131 and 132 maybe formed circumferentially on the substrates. In order to have a desired number of windings, the primary and secondary conductors 131 and 132 may be formed to have a spiral shape around the through hole H.

When a large amount of windings are required, the primary and secondary conductors 131 and 132 may be individually formed on the plurality of substrates. Via holes may be provided to form an electrical connection between the primary conductors 131 of the individual substrates or to form an electrical connection between the secondary conductors 132 of the individual substrates.

The opening part 140 may be formed on the pattern part 130.

That is, the opening part 140 may be formed of a non-conductor allowing for variations in the width of the conductors of the pattern part 130. The opening part 140 may be formed by removing parts of the conductors of the pattern part 130 using an etching process so as lo make the width variable.

The opening part 140 may be formed as a first opening 141 and a second opening 142 on the conductors of the pattern part 130.

The first and second openings 141 and 142 may be formed on each conductor of the pattern part 130.

It may be assumed that since current flows through the conductors of the pattern part 130, the opening part 140 reduces the area through which the current flows, therefore, the restriction on current flow caused thereby may lead to increased heat generation. However, considering a surface effect, in which when an electric charge flows through the conductors, the electric charge is concentrated on the surfaces thereof after a predetermined time, the removal of parts of the conductors may suppress charge collisions between the conductors, and thus heat generation may be reduced.

The first opening 141 may be disposed on a portion of the pattern part 130 overlapped by the core part 110. The second opening 142 may be disposed on a portion of the pattern part 130 that is not overlapped by the core part 110 (such that the conductors of the pattern part 130 may be partially exposed).

The first and second openings 141 and 142 may be physically connected to each other.

The first opening 141 may be formed on the portion of the pattern part 130 overlapped by the core part 110, considering heat generated by the flux of the core part 110.

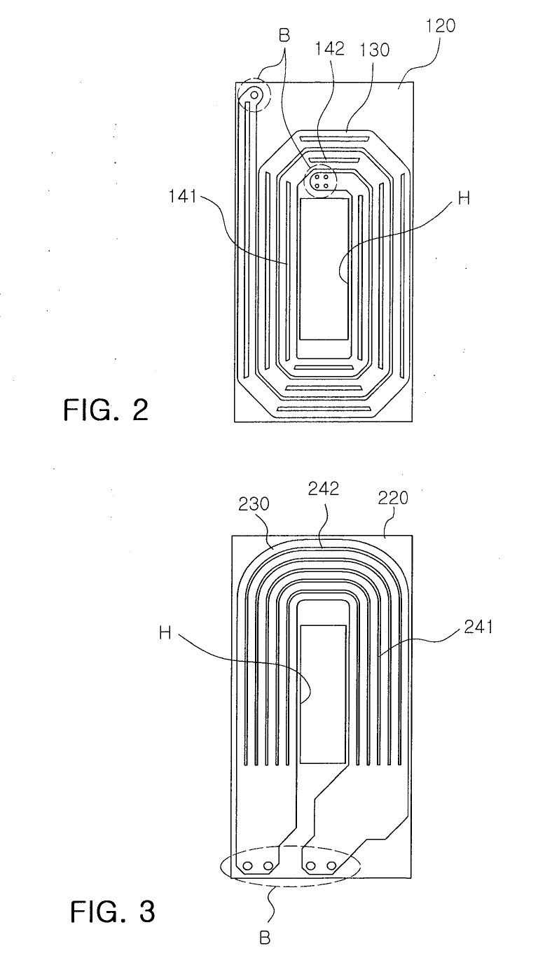

FIG. 2 is a view illustrating the configuration of a pattern part and an opening part according to an exemplary embodiment of the present invention.

With reference to FIG. 2, according to an exemplary embodiment of the invention, the pattern part 130 may be formed to have a spiral shape on the substrate part 120 around the through hole H.

The first and second openings 141 and 142 may be formed on the pattern part 130 by removing parts of each conductor of the pattern part 130. The first and second openings 141 and 142 may be formed linearly in conformity with the shape of the conductor.

Further, the first opening 141 may be disposed on a portion of the pattern part 130 overlapped by the core part 110, and the second opening 142 may be disposed on a portion of the pattern part 130 that is not overlapped by the core part 110. Via holes B may be provided at one end and the other end of a conductor so as to make an electrical connection with a conductor formed on another substrate.

FIG. 3 is a view illustrating the configuration of a pattern part and an opening part according to another exemplary embodiment of the present invention.

With reference to FIG. 3, according to another exemplary embodiment of the invention, a pattern part 230 may be formed on a substrate part 220 circumferentially.

First and second openings 241 and 242 may be formed on the pattern part 230 by removing parts of each conductor of the pattern part 230. The first and second openings 241 and 242 may be formed linearly in conformity with the shape of the conductor.

Further, the first opening 241 may be disposed on a portion of the pattern part 230 overlapped by the core part 210, and the second opening 242 may be disposed on a portion of the pattern part 230 that is not overlapped by the core part 210.

Likewise, via holes B may be provided at one end and the other end of a conductor so as to make an electrical connection with a conductor formed on another substrate.

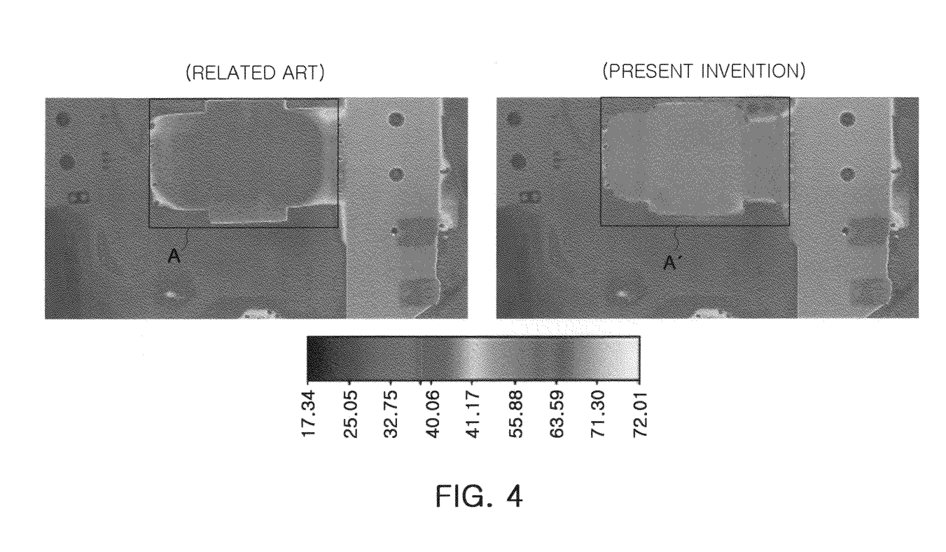

FIG. 4 is an image showing heat generated from a circuit board on which a planar transformer according to an exemplary embodiment of the present invention is mounted and from a circuit board on which a planar transformer according to the related art is mounted.

With reference to FIG. 4, a planar transformer A′ according to an exemplary embodiment of the invention includes an opening part formed by removing parts of a conductor of a pattern part so that the planar transformer A′ may have a reduction in heat generated therefrom, as compared with heat generated from a planar transformer A according to the related art.

In particular, the overlapping portion of a core part and the pattern part shows a clear temperature differential in the amount of heat being generated.

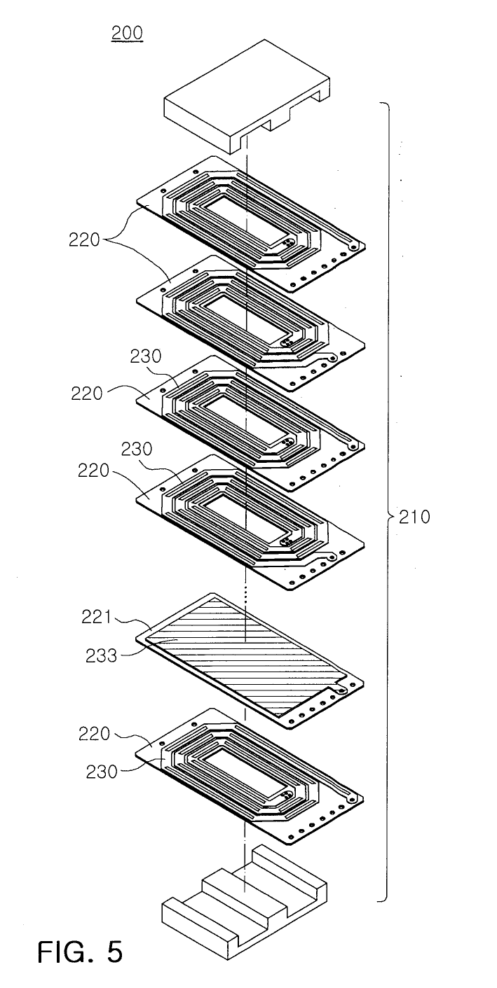

FIG. 5 is a schematic exploded view illustrating the configuration of a planar transformer according to another exemplary embodiment of the present invention.

With reference to FIG. 5, a planar transformer 200 according to another exemplary embodiment of the invention may further include a ground substrate 221 disposed between a plurality of stacked substrates 220, on an uppermost substrate thereof or on a lowest substrate thereof.

A ground pattern 223 may be formed of a conductor on a surface of the ground substrate 221. The ground pattern 223 may be electrically connected to a ground of a pattern part 230. Heat generated when current flows through the pattern part 230 is radiated to the ground pattern 223 widely formed on a surface of the ground substrate 221, so that the heat generated from the planar transformer 200 may be further reduced.

As described above, part of a conductor of a pattern part is removed so that while the functionality thereof may be maintained by allowing for the flow of current through the pattern part, a reduction of an area, in which heat is generated when the current flows through the conductor, may be achieved. In addition, a planar transformer employs a ground substrate having a ground pattern so that its temperature characteristics may be controlled to be suitable for a consumer's requirements.

As set forth above, according to exemplary embodiments of the invention, a planar transformer has improved performance through a reduction in heat generation by removing parts of a conductor from a substrate.

While the present invention has been shown and described in connection with the exemplary embodiments, it will be apparent to those skilled in the art that modifications and variations can be made without departing from the spirit and scope of the invention as defined by the appended claims.

What is claimed is:

1. A planar transformer comprising:
a core part having a pair of cores being electromagnetically coupled to each other;
a substrate part having at least one substrate disposed between the pair of cores;
a pattern part formed on the at least one substrate and including a conductor having an adjustable width; and
an opening part including a non-conductor allowing for variations in the width of the conductor of the pattern part.

2. The planar transformer of claim 1, wherein the at least one substrate of the substrate part has a through hole coupled to the core part.

3. The planar transformer of claim 2, wherein the pattern part is formed circumferentially around the through hole of the at least one substrate.

4. The planar transformer of claim 3, wherein the pattern part is formed in a spiral shape circumferentially around the through hole of the at least one substrate.

5. The planar transformer of claim 1, wherein the substrate part includes a first substrate and a second substrate being stacked,
the pattern part includes a primary conductor formed on the first substrate and a secondary conductor formed on the second substrate, and
the primary and secondary conductors have a preset winding ratio therebetween.

6. The planar transformer of claim 1, wherein the opening part includes a first opening disposed on a portion of the pattern part overlapped by the core part.

7. The planar transformer of claim 6, wherein the opening part includes a second opening disposed on a portion of the pattern part that is not overlapped by the core part (such that the portion of the pattern part is exposed).

8. The planar transformer of claim 7, wherein the first and second openings are connected to each other.

9. The planar transformer of claim 1, wherein the opening part is formed within the conductor of the pattern part.

10. The planar transformer of claim 1, wherein the substrate part further includes at least one ground substrate,
the ground substrate has a ground pattern formed on a surface thereof, the ground pattern being formed of a conductor, and
the ground pattern is electrically connected to a ground of the pattern part formed on the at least one substrate.

11. A planar transformer comprising:
a core part having a pair of cores being electromagnetically coupled to each other;
a substrate part, having at least one substrate disposed between the pair of cores;
a pattern part formed on the at least one substrate and including a conductor; and
an opening part formed by removing part of the conductor of the pattern part.

12. The planar transformer of claim 11, wherein the at least one substrate of the substrate part has a through hole coupled to the core part.

13. The planar transformer of claim 12, wherein the pattern part is formed circumferentially around the through hole of the at least one substrate.

14. The planar transformer of claim 13, wherein the pattern part is formed in a spiral shape circumferentially around the through hole of the at least one substrate.

15. The planar transformer of claim 11, wherein the substrate part includes a first substrate and a second substrate being stacked,
the pattern part includes a primary conductor formed on the first substrate and a secondary conductor formed on the second substrate, and
the primary and secondary conductors have a preset winding ratio therebetween.

16. The planar transformer of claim 11, wherein the opening part includes a first opening disposed on a portion of the pattern part overlapped by the core part.

17. The planar transformer of claim 16, wherein the opening part includes a second opening disposed on a portion of the pattern part that is not overlapped by the core part (such that the portion of the pattern part is exposed).

18. The planar transformer of claim 17, wherein the first and second openings are connected to each other.

19. The planar transformer of claim 11, wherein the opening part is formed within the conductor of the pattern part.

20. The planar transformer of claim 11, wherein the substrate part further includes at least one ground substrate,
the ground substrate has a ground pattern formed on a surface thereof, the ground pattern being formed of a conductor, and
the ground pattern is electrically connected to a ground of the pattern part formed on the at least one substrate.
